(19) United States
(12) Patent Application Publication
(10) Pub. No.: US 2025/0167867 A1
(43) Pub. Date: May 22, 2025

(54) INFORMATION PROCESSING METHOD, INFORMATION TRANSMITTING METHOD AND APPARATUSES THEREOF

(71) Applicant: FUJITSU LIMITED, Kawasaki-shi (JP)

(72) Inventors: Yang LU, Beijing (CN); Lei ZHANG, Beijing (CN); Qinyan JIANG, Beijing (CN)

(73) Assignee: FUJITSU LIMITED, Kawasaki-shi (JP)

(21) Appl. No.: 19/028,847

(22) Filed: Jan. 17, 2025

Related U.S. Application Data
(63) Continuation of application No. PCT/CN2022/110718, filed on Aug. 5, 2022.

(51) Int. Cl. H04B 7/06; H04W 52/02

(52) U.S. Cl. CPC H04B 7/06968; H04B 7/0626; H04W 52/0235

(57) ABSTRACT

An information processing apparatus, for a terminal equipment, includes: a receiver configured to receive first indication information transmitted by a network side device, the first indication information being used to indicate identification information of a first cell, and receive a first synchronization signal block (SSB) of the first cell transmitted by the network side device; and processor circuitry configured to perform downlink reception of a reference signal of a second cell; wherein the reference signal of the second cell and the first synchronization signal block of the first cell are in a quasi-colocated (QCL) relationship.

### CROSS-REFERENCE TO RELATED APPLICATION

This application is a continuation application of International Application PCT/CN2022/110718 filed on Aug. 5, 2022, and designated the U.S., the entire contents of which are incorporated herein by reference.

### TECHNICAL FIELD

This disclosure relates to the field of communication technologies.

### BACKGROUND

As a NR (New Radio) base station needs to operate at large a bandwidth (such as 100 MHz), a large number of ports (64T/64R) and shorter TTIs (transmission time intervals) (such as 1 ms) need to be used, the NR base station has significantly higher energy consumption overhead in baseband processing, digital front-end, and other functions compared to an LTE (long-term evolution) base station. Moreover, an FR2 (frequency range 2) operating frequency of NR is relatively high (>6 GHz), and the higher the frequency, the greater a pathloss of a signal. Therefore, a design principle of NR is to use a narrower beam to transmit the signal farther. In this way, the number of antenna units used by the NR base station for analog beamforming will greatly increase, resulting in increases in the numbers of RF units and RF channels for transmitting and receiving signals. Each RF channel is equipped with a power amplifier (PA), which accounts for about 80% of the total energy consumption of the base station, and as the number of PAs increases, the energy consumption of the base station also increases. A current FR1 (frequency range 1) frequency band AAU (active antenna unit) generally uses 192 antenna units and supports 64 channels, which is much larger than a maximum of 8 channels of LTE.

According to data statistics of operators, average energy consumption of an NR base station exceeds three times that of an LTE base station, and nearly 50% of the cost an operator to deploy 5G (5th generation) networks is electricity expenses. More importantly, an NR base station still incurs significant energy consumption even during periods of no service, as it still needs to transmit common signals even if there is no service, such as SSBs (synchronization signal blocks), SIB1 (first system information block), and SI (system information), etc., thereby greatly reducing energy efficiency of the NR base station. Energy saving of NR networks is an urgent issue that needs to be addressed.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In 3GPP Rel-15/Rel-16 (3rd Generation Partnership Project Release 15/Release 16), it is supported that in an intra-band carrier aggregation (CA) scenario, a secondary cell (SCell) of a terminal equipment may not transmit synchronization signal blocks (SSBs), and the terminal equipment obtains downlink synchronization of the SCell from SSBs transmitted by a special cell (SpCell). At the same site, at least one cell transmits SSBs, and only a cell that transmits SSBs may serve as the SpCell of terminal equipment.

It was found by the inventors that in the related art, at least one of cells in the same site must transmit SSBs, and in addition, a serving cell (at least the SpCell) of the terminal equipment must transmit SSBs. Hence, even when there is no service at the site, energy cost is still high, which is not conducive to energy saving of the network.

Furthermore, for energy saving of the network, even if all serving cells of the terminal equipment stop transmitting SSBs or extend transmission periods of SSBs, it means that the terminal equipment loses downlink synchronization and downlink channel estimation signals of the serving cells, that is, the terminal equipment is unable to perform measurement based on the SSBs of the serving cells. Therefore, the serving cells of the terminal equipment are unable to serve for the terminal equipment. A terminal equipment originally connected to the serving cells must be handed over to a neighboring cell, and a terminal equipment originally camped on the serving cells will perform cell reselection to camp on the neighboring cell. FIG. 1 is a schematic diagram of energy saving scheme of a network. As shown in FIG. 1, for energy saving of the network, for the SpCell of the terminal equipment, the network device may dynamically activate and deactivate based on traffics, measurement reports and other information of an NR cell and its neighboring cell. When a cell is deactivated, transmission of synchronization signal blocks and system information is stopped, and reception of uplink signals transmitted by the terminal equipment is stopped. In this way, in case of lower traffics, energy consumption of the SpCell may be saved.

Thus, when the cell enters an energy-saving state, the terminal equipment is handed over to the neighboring cell and inform a NR neighboring network device or LTE network device that the NR cell has entered the energy-saving state. The neighboring NR/LTE network device undertakes a coverage area and traffics of the NR cell. Afterwards, the neighboring NR/LTE network devices determines whether to request the NR cell that has entered the energy-saving state to resume normal operations according to their own traffic, and measurement reports, etc. For example, when their own traffics reaches a threshold, they trigger requesting the NR cell that has entered the energy-saving state to resume normal operations. When the NR cell resumes normal operations, some terminal equipments that were previously handed over to a neighboring NR/LTE cell may be handed back to the NR cell.

It was found by the inventors that in the above scheme, when the NR cell dynamically enters the energy-saving state for multiple times, the terminal equipment also is frequently handed out of the NR cell or frequently perform cell reselection, thereby affecting user experiences. In addition, migration of the terminal equipment of the cell in the energy-saving state to the neighboring cell inevitably increases a load level of the neighboring cell, and affect service quality of the terminal equipment of the neighboring cell.

In order to solve at least one of the above problems, embodiments of this disclosure provide an information processing method, an information transmitting method and apparatuses thereof.

According to one aspect of the embodiments of this disclosure, there is provided an information transmitting apparatus, applicable to a network side device, the apparatus including:
a second transmitting unit configured to stop transmitting to a terminal equipment a first synchronization signal block of a first cell that should be transmitted, and transmit or stop transmitting to the terminal equipment a second synchronization signal block of a second cell that should be transmitted,
wherein the first synchronization signal block of the first cell and the second synchronization signal block of the second cell are in a quasi-colocated (QCL) relationship.

According to another aspect of the embodiments of this disclosure, there is provided an information processing apparatus, applicable to a terminal equipment, the apparatus including:
a first receiving unit configured to receive a second synchronization signal block (SSB) of a second cell transmitted by a network side device; and
a first processing unit configured to perform downlink reception of a reference signal of a first cell or determine a measurement result of a first cell according to the second synchronization signal block,
wherein a first synchronization signal block of the first cell and the second synchronization signal block of the second cell are in a quasi-colocated (QCL) relationship.

According to a further aspect of the embodiments of this disclosure, there is provided an information transmitting apparatus, applicable to a terminal equipment, the apparatus including:
a first transmitting unit configured to, when the terminal equipment initiates random access in a first cell or performs RLM/BFD/RRM measurement based on a first synchronization signal block of a first cell or performs measurement for cell selection or reselection on a first cell, and the terminal equipment fails to receive or measure the first synchronization signal block of the first cell, transmit a first wake-up signal to a network side device, the first wake-up signal being used to indicate the network side device to resume transmitting the first synchronization signal block of the first cell.

An advantage of the embodiments of this disclosure exists in that the terminal equipment may perform downlink reception of the reference signal of the energy-saving cell or determine the measurement result of the energy-saving cell according to synchronization signal blocks of other cells, and the terminal equipment may perform random access, RLM/BFD/RRM measurement based on CSI-RSs or SSBs and measurement for cell selection or reselection in the energy-saving cell. Thus, the terminal equipment is not necessarily handed over to other cells, and the terminal equipment originally camping on the energy-saving cell does not necessarily perform cell reselection. This may avoid service interruption and increase of the load level of the neighboring cell resulted from migrating the terminal equipment of the energy-saving cell to the neighboring cell, and ensure that user experiences are not reduced when the cell enters the energy-saving state.

Another advantage of the embodiments of this disclosure exists in that the terminal equipment may transmit a wake-up signal to cause the energy-saving cell that has stopped transmitting SSBs to resume transmission of SSBs, and according to the SSBs resumed to be transmitted, perform random access, RLM/BFD/RRM measurement based on CSI-RSs or SSBs, measurement for cell selection or reselection, etc., in the energy-saving cell. Hence, the terminal equipment is not necessarily handed over to other cells, and the terminal equipment originally camping on the energy-saving cell does not necessarily perform cell reselection, which may avoid service interruption and increase of the load level of the neighboring cell resulted from migrating the terminal equipment of the energy-saving cell to the neighboring cell.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of a distributed network energy-saving scheme;

FIG. 3 is a schematic diagram of an information processing method of embodiments of this disclosure;

FIG. 4 is another schematic diagram of an information processing method of embodiments of this disclosure;

FIG. 5 is a schematic diagram of an information transmitting method of embodiments of this disclosure;

FIG. 6 is another schematic diagram of an information transmitting method of embodiments of this disclosure;

FIG. 7 is a schematic diagram of an information transmitting apparatus of embodiments of this disclosure;

FIG. 8 is another schematic diagram of an information processing apparatus of embodiments of this disclosure;

FIG. 9 is another schematic diagram of an information transmitting apparatus of embodiments of this disclosure;

FIG. 10 is a schematic diagram of a network device of embodiments of this disclosure; and

FIG. 11 is a schematic diagram of a terminal equipment of embodiments of this disclosure.

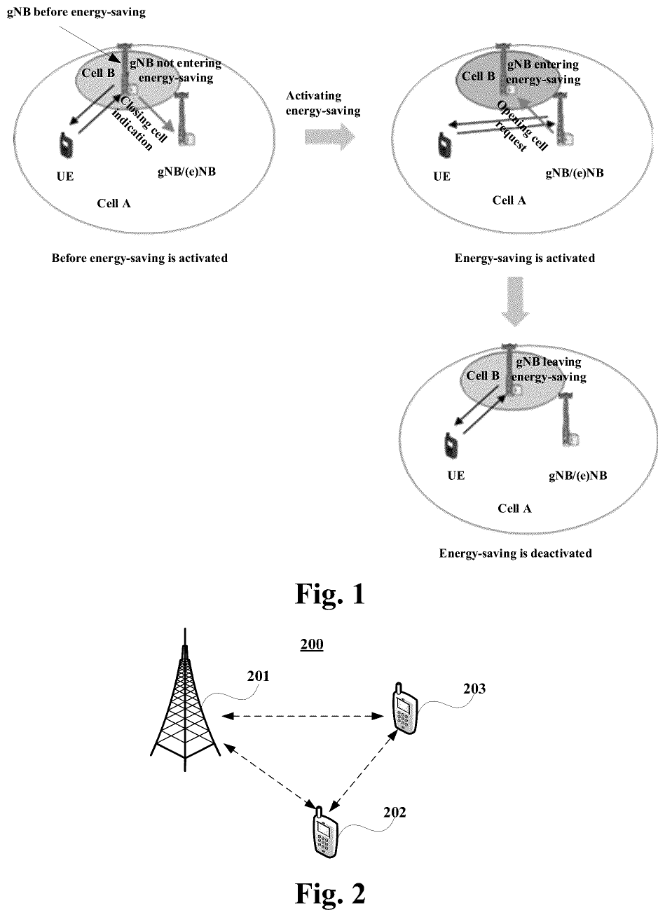

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), an IAB (integrated access and backhaul) node or an IAB-DU or an IAB-donor. The term “base station” may include some or all of its functions, and each base station may provide communication coverage for a specific geographical area. And a term “cell” may refer to a base station and/or its coverage area, depending on a context of the term. Without causing confusion, the term “cell” and the term “base station” are interchangeable.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of embodiments of this disclosure, in which a case where terminal equipment and a network device are taken as examples is schematically shown. As shown in FIG. 2, the communication system 200 may include a network device 201 and terminal equipment 202, 203. For the sake of simplicity, an example having only two terminal equipment and one network device is schematically given in FIG. 2; however, the embodiments of this disclosure are not limited thereto.

In the embodiments of this disclosure, existing services or services that may be implemented in the future may be performed between the network device 201 and the terminal equipments 202, 203. For example, such services may include but not limited to an enhanced mobile broadband (eMBB), massive machine type communication (mMTC), and ultra-reliable and low-latency communication (URLLC), etc.

The terminal equipment 202 may transmit data to the network device 201, such as in a granted or grant-free transmission manner. The network device 201 may receive data transmitted by one or more terminal equipment 202 and feed back information to the terminal equipment 202, such as acknowledgement (ACK)/non-acknowledgement (NACK) information. According to the feedback information, the terminal equipment 202 may acknowledge end of a transmission process, or may perform new data transmission, or may perform data retransmission.

It should be noted that FIG. 2 shows that two terminal equipment 202, 203 are both in coverage of the network device 201. However, this disclosure is not limited thereto, and the two terminal equipment 202, 203 may not be in coverage of the network device 201, or one terminal equipment 202 is in coverage of the network device 201 and the other terminal equipment 203 is out of coverage of the network device 201.

Embodiments of this disclosure shall be described below with reference to implementations and the accompanying drawings.

### Embodiments of a First Aspect

The embodiments of this disclosure provide an information processing method, which shall be described from a terminal equipment side.

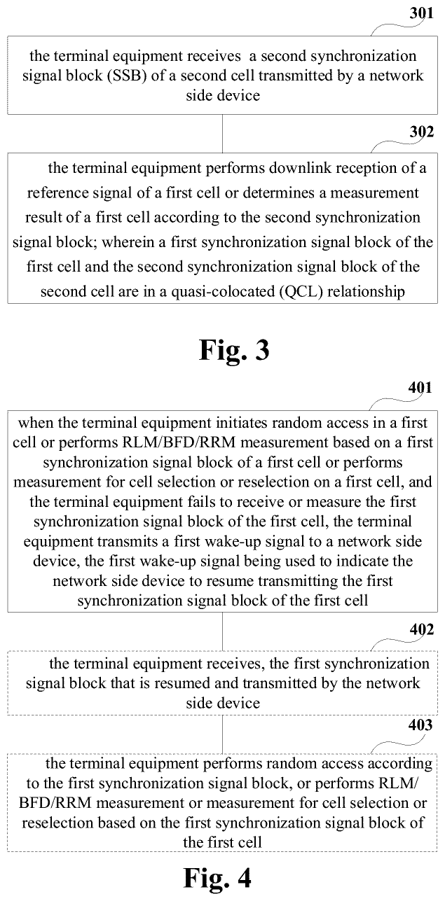

FIG. 3 is a schematic diagram of the information processing method of the embodiments of this disclosure, applicable to a terminal equipment. As shown in FIG. 3, the method includes:
301: the terminal equipment receives a second synchronization signal block (SSB) of a second cell transmitted by a network side device; and
302: the terminal equipment performs downlink reception of a reference signal of a first cell or determines a measurement result of a first cell according to the second synchronization signal block,
wherein a first synchronization signal block of the first cell and the second synchronization signal block of the second cell are in a quasi-colocated (QCL) relationship.

It should be noted that FIG. 3 only schematically illustrates the embodiments of this disclosure; however, this disclosure is not limited thereto. For example, some other steps may be added, or some steps therein may be reduced. And appropriate variants may be made by those skilled in the art according to the above contents, without being limited to what is contained in FIG. 3.

In some embodiments, when there is no service, the network side may stop transmitting synchronization signal blocks of one or more serving cells of the terminal equipment, or extend transmission periods of the synchronization signal blocks (such as from 20 ms to 320 ms). Stopping transmitting synchronization signal blocks below may also refer to extending periods of the synchronization signal blocks. A synchronization signal block of the first cell (also known as a first carrier) below is referred to as a first synchronization signal block, the first cell is the serving cell that stops transmitting the synchronization signal blocks. The first cell may be a special cell (such as a primary cell PCell or a primary secondary cell PSCell) of the terminal equipment, or a non-special cell (such as an SCell) of the terminal equipment. For example, the first cell is a special cell (SpCell) of the terminal equipment when it is in a connected state, or a cell selected or reselected by the terminal equipment when it is in an idle or inactive state; however, the embodiments of this disclosure are not limited thereto. Thus, energy consumption of the network side may be saved, and the first cell may also be referred to as an energy-saving cell (or an SSB-less cell). The synchronization signal blocks (also known as synchronization signal and PBCH blocks, abbreviated as SSBs) may include a primary synchronization signal, PSS), a secondary synchronization signal, SSS), and/or a physical broadcast channel, PBCH).

In some embodiments, although the first cell stops transmitting SSBs, other cells at the same site as the first cell may transmit SSBs, that is, the second cell (or referred to as a second carrier) may be another cell at the same site as the first cell that transmits synchronization signal blocks. A synchronization signal block of the second cell is referred to as a second synchronization signal block. The second cell may be a special cell of the terminal equipment (such as a primary cell PCell or a primary secondary cell PSCell), or a non-special cell (such as an SCell) of the terminal equipment. The second cell may also be referred to as a reference cell or an anchor cell, and the embodiments of this disclosure are not limited thereto. That is, in 301, the terminal equipment receives a second synchronization signal block of the second cell transmitted by the network side device.

In some embodiments, when the terminal equipment is unable to successfully receive the first synchronization signal block transmitted by the network side device (transmission of the first SSB of the first cell is stopped), such as when a transmission period of the first synchronization signal block exceeds a preset threshold, the second SSB transmitted on the second cell may provide downlink channel estimation information for the first cell, or, in other words, the terminal equipment may obtain downlink channel estimation information of the first cell according to the SSB of the second cell at the same site. The terminal equipment may perform downlink reception of a reference signal of the first cell or determine a measurement result of the first cell according to the second SSB, and may perform random access, radio link monitoring (RLM) based on CSI-RSs or SSBs, beam failure detection (BFD), radio resource management (RRM) measurement, measurement of cell selection or reselection, etc., in the first cell. Hence, the terminal equipment is not necessarily handed over to other cells, and the terminal equipment originally camped on the first cell does not necessarily perform cell reselection, which may avoid service interruption and increase of the load level of the neighboring cell resulted from migrating the terminal equipment of the energy-saving cell to the neighboring cell, and ensure that user experiences are not degraded when the cell enters the energy-saving state.

In some embodiments, the first synchronization signal block of the first cell and the second synchronization signal blocks of the second cell are in a quasi-colocated QCL relationship, types of the QCL relationship including QCL type C and QCL type D. Specifically, the first synchronization signal block and the second synchronization signal blocks\in the quasi-colocated relationship have identical index. In other words, the first SSB and the second SSBs having identical index are in a quasi-colocated relationship. The quasi-colocated relationship may be indicated by second indication information, which shall be described later. In addition, if the number of second synchronization signal blocks that are transmitted is less than the number of first synchronization signal blocks that should have been transmitted, the terminal is unable to determine a measurement result of the first synchronization signal blocks based on the second synchronization signal blocks. Therefore, in a synchronization signal block period, the number of transmitted second synchronization signal blocks is not less than the number of the first synchronization signal blocks that should have been transmitted. Subcarrier spacings, periods and/or transmit power of the first synchronization signal blocks of the first cell and the second synchronization signal blocks of the second cell may be identical or different. The network side device may transmit configuration information of the SSBs (such as configuration information of the first SSBs and configuration information of the second SSBs) to the terminal side in advance, wherein the configuration information may be expressed as follows by using ASN.1 data format:

| | |
|---|---|
| ssb-PositionsInBurst | CHOICE { |
| shortBitmap | BIT STRING (SIZE (4)), |
| mediumBitmap | BIT STRING (SIZE (8)) , |
| longBitmap | BIT STRING (SIZE (64)) |
| } | |
| OPTIONAL, -- Cond AbsFreqSSB | |
| ssb-periodicityServingCell | ENUMERATED { ms5, ms10, ms20, ms40, |
| ms80, ms160, spare2, spare1 } | OPTIONAL, -- Need S |
| ssbSubcarrierSpacing | SubcarrierSpacing |
| OPTIONAL, -- Cond HOAndServCellWithSSB | |
| ss-PBCH-BlockPower | INTEGER (−60..50), |

For example, the number of positions of SSBs indicated by an information element ssb-PositionsInBurst of the second cell is not less than the number of positions of SSBs indicated by the same information element of the first cell, but periods ssb-periodicityServingCell, subcarrier spacings ssbSubcarrierSpacing and transmit power ss-PBCH-BlockPower thereof may be identical or different.

In some embodiments, the network side device may indicate the network side device via the first indication information to stop transmitting the first SSB that should have been transmitted. The first indication information may be expressed by one or more bits, and is further used to indicate indices of the first synchronization signals that have been stopped and should have been transmitted. The network device of the first cell may transmit the first indication information before stopping transmitting the first SSB, and the first indication information may be carried by system information or a dedicated RRC message.

For example, the first indication information may be a newly-added information element in the system information or dedicated RRC message. When the newly-added information element is not included in the system information or dedicated RRC signaling, it indicates that all SSBs of the first cell are transmitted normally; and when the newly-added information element is included in the system information or dedicated RRC signaling, it indicates that the first SSB of the first cell that should have been transmitted are stopped transmitting. A value of the information element is further used to indicate indices of the stopped transmitted first SSB that should have been transmitted. For example, the information element may be denoted by a bitmap, each bit of the bitmap corresponding to an index of an SSB. If a value of the bit is 1, it indicates that the SSB of the index is transmitted normally, and if the value of the bit is 0, it indicates that the SSB of the index is stopped transmitting, and vice versa; or, the information element may also indicate indices of the SSBs (SSB index) that should have been transmitted and are stopped transmitting by using values of N bits; however, the embodiments of this disclosure are not limited thereto.

In some embodiments, the network side device may indicate by transmitting second indication information that the terminal equipment is able to perform downlink reception of a reference signal of the first cell or determine the measurement result of the first cell via the second synchronization signal blocks. When the terminal equipment receives the second indication information, it indicates that the terminal equipment is able to perform downlink reception of a reference signal of the first cell or determine the measurement result of the first cell via the second synchronization signal blocks. The transmitted second indication information may indicate identification information of the second cell. In other words, when the terminal equipment receives the second indication information indicating the identification information of the second cell, it is able to perform downlink reception of a reference signal of the first cell or determine the measurement result of the first cell via the second synchronization signal blocks. If the terminal equipment does not receive the second indication information, it is unable to perform downlink reception of a reference signal of the first cell or determine the measurement result of the first cell via the second synchronization signal blocks. Hence, if the terminal equipment needs to perform downlink reception of a reference signal of the first cell or determine the measurement result of the first cell, it needs to transmit a wake-up signal to enable the first SSB to be resumed transmitting. Relevant embodiments of the wake-up signal shall be described in embodiments of a second aspect.

In some embodiments, the second indication information may also be used to indicate that the first synchronization signal blocks and the second synchronization signal blocks are in a quasi-colocation relationship, so that the terminal equipment performs downlink reception of a reference signal of the first cell or determines the measurement result of the first cell via the second synchronization signal blocks.

In some embodiments, the network device of the first cell may transmit second indication information before stopping transmitting the first SSB, the second indication information being carried by system information or a dedicated RRC message.

For example, the second indication information may be a newly-added information element in the system information or dedicated RRC message, and include identification information of the second cell, and the cell identifier may be an NCGI or PCI. When the system information or dedicated RRC signaling does not include the information element, it indicates that the terminal equipment is unable to perform downlink reception of a reference signal of the first cell or determine the measurement result of the first cell via the second synchronization signal blocks, and when the system information or dedicated RRC signaling includes the information element, it indicates that the terminal equipment is able to perform downlink reception of a reference signal of the first cell or determine the measurement result of the first cell via the second synchronization signal blocks.

For example, the newly-added information element may be a quasi-colocated cell identification information element, and include the identification information of the second cell to indicate that the first synchronization signal blocks of the first cell and the second synchronization signal blocks of the second cell are in a quasi-colocated relationship. When the system information or dedicated RRC signaling includes the information element, it indicates that the terminal equipment is able to perform downlink reception of a reference signal of the first cell or determine the measurement result of the first cell via the second synchronization signal blocks.

It should be noted that the above-described network side device that transmits/stops transmitting the first SSB of the first cell and the network side device that transmits the second SSB of the second cell may be identical or different network devices, and the above-described network side device that transmits the first indication information and second indication information and receives the wake-up signal and the network side device that transmits/stops transmitting the first SSB of the first cell may also be identical or different network side devices.

In some embodiments, as described above, when the terminal equipment receives the second indication information, it may perform downlink reception of a reference signal of the first cell or determine the measurement result of the first cell via the second synchronization signal blocks. For example, according to the second synchronization signal blocks, it performs random access on the first cell, performs RLM/BFD/RRM measurement based on CSI-RSs or SSBs of the first cell, and performs measurement for cell selection and/or reselection on the first cell, etc., which shall be described below in detail.

In some embodiments, in 302, the terminal equipment may determine the measurement result of the first cell according to the second synchronization signal blocks, the measurement result including one of received power (RSRP), received quality (RSRQ), and a signal to interference plus noise ratio (SINR). The terminal equipment may take (the first SSB of) the first cell as a measurement object, or may take (the second SSB of) the second cell as a measurement object, which shall be described below respectively.

In one aspect, the terminal equipment takes the first SSB as measurement object. In measuring the first SSB, a second measurement result of the second SSB is taken as a first measurement result of the first SSB (with index identical to that of the second SSB). The measurement result includes an L1 measurement result for the first synchronization signal block, or an L3 measurement result for the first synchronization signal block. The terminal equipment may perform random access, RLM/BFD/RRM measurement and measurement for cell selection or reselection based on the first measurement result. Reference may be made to the related art for processes of the random access, RLM/BFD/RRM measurement and measurement for cell selection or reselection, which shall be described later by way of examples.

In another aspect, when the first cell initiates random access, the terminal equipment takes the second SSB as the measurement object and measures the L1 received power of the second SSB. The terminal equipment selects a first synchronization signal block for performing random access in the first cell according to the second measurement result (replacing or substituting the first measurement result of the first synchronization signal block) of the second synchronization signal block. Or, the terminal equipment selects second synchronization signal block for performing random access according to the second measurement result of the second synchronization signal block, and determines that synchronization signal block associated with PRACH resources (with index identical thereto) of the first cell as the second synchronization signal block, so that the terminal equipment may determine the PRACH resources of the first cell according to the selected second synchronization signal block.

In a further aspect, in executing RLM/BFD based on the first synchronization signal block, the terminal equipment takes the second SSB as a measurement object and measures L1 received power of the second SSB. The terminal equipment determines that a synchronization signal block of radio link detection or beam failure detection based on the first synchronization signal block (with index identical thereto) is the second synchronization signal block. Thus, the terminal equipment performs radio link failure detection or beam failure detection on the first cell based on the second measurement result of the second synchronization signal block.

In still another aspect, in performing RRM measurement based on the first synchronization signal block, the terminal equipment takes the second SSB as a measurement object and measures L3 received power, received quality, or signal-to-interference ratios of the second SSB. The terminal equipment determines that a synchronization signal block of RRM measurement based on the first synchronization signal block is the second synchronization signal block (with index identical thereto), and measures the second synchronization signal block according to configuration parameters of the second synchronization signal block, so as to perform radio resource management (RRM) measurement of the first cell.

In yet another aspect, in performing cell selection or reselection or RRM measurement on the first cell, the terminal equipment takes the first cell as a measurement object and measures L3 received power, received quality or a signal-to-interference ratio of the first cell. The terminal equipment takes a measurement result of the second cell as a measurement result of the first cell.

In yet still another aspect, in performing cell selection or reselection or RRM measurement on the first cell, the terminal equipment takes the second cell as a measurement object and measures L3 received power, received quality or a signal-to-interference ratio of the second cell. Thus, the terminal equipment measures the second cell, so as to determine the measurement result of the first cell.

Hence, the terminal equipment may perform random access, RLM/BFD/RRM measurement and measurement for cell selection or reselection based on the second SSB or the measurement result of the second cell, which shall be described in detail later.

In some embodiments, in 302, the terminal equipment may perform downlink reception of the reference signal of the first cell according to the second synchronization signal block, wherein the reference signal of the first cell includes: a CSI-RS. The CSI-RS is in a QCL relationship with the first SSB, that is, the terminal equipment performs downlink reception of the CSI-RS in a QCL relationship with the first SSB according to the second SSB, and performs RLM/BFD/RRM measurement or contention-free random access based on the received CSI-RS. The CSI-RS may be received according to the first SSB, or, the CSI-RS may be received according to the second SSB, which shall be respectively described below.

In one aspect, when the terminal equipment receives the CSI-RS that is in a quasi-colocation relationship with the first synchronization signal block, it takes second downlink reception parameters for receiving the second synchronization signal block as first downlink reception parameters for receiving the first synchronization signal block, and receives the CSI-RS according to the first downlink reception parameters, wherein the downlink reception parameters include a Doppler shift, Doppler spread, average latency, latency spread, and a spatial reception parameter. That is, the terminal equipment takes the second downlink reception parameter as the first downlink reception parameters to receive the first SSB, and receives the CSI-RS based on the first downlink reception parameters for receiving the first SSB.

In another aspect, when the terminal equipment receives the CSI-RS that is in a quasi-colocation relationship with the first synchronization signal block, the terminal equipment determines that the quasi-colocation relationship between the CSI-RS and the first synchronization signal block of the first cell is identical to the quasi-colocation relationship between the CSI-RS and the second synchronization signal block of the second cell, and receives the CSI-RS according to the second downlink reception parameters for receiving the second synchronization signal. That is, the terminal equipment does not need to receive the first SSB, but receives the second SSB, and receives the CSI-RS based on the second downlink reception parameters for receiving the second SSB.

Thus, the terminal equipment may perform RLM/BFD/RRM measurement or contention-free random access based on the CSI-RS, which shall be described later by way of examples.

### (1) Random Access

In an existing NR system, contention-based random access needs to select SSBs for random access according to received power of SSBs (SS-RSRP) of a cell currently initiating the random access. First, an SSB with SS-RSRP higher than a preset threshold is select, and a random access occasion (RO) is determined according to the selected SSB, that is, a next available random access occasion to which the SSB corresponds is selected. Then, a preamble is randomly selected from a preamble group related to the SSB. Finally, the selected preamble is transmitted on a corresponding resource of the selected random access occasion, so as to initiate a random access procedure. That is, each valid RO and a preamble sequence contained therein is mapped in association with the SSB, and after an SSB is selected, a preamble sequence is selected and transmitted on a corresponding RO resource according to a rule of mapping from an SSB to an RO.

For a terminal equipment in a connected state, contention-based random access is generally initiated in a PCell or PSCell of the terminal equipment in a connected state, such as during RRC connection reestablishment, arrival of uplink data in uplink out-of-synch and RRC connected state, uplink LBT failure, scheduling request (SR) failure, no available PUCCH resource for an SR and arrival of uplink data in an RRC connected state, having a positioning demand, etc.

For a terminal equipment in an idle/inactive state, the terminal equipment initiates contention-based random access in a camping cell, such as initial access in the RRC idle state, an RRC connection recovery procedure in the RRC inactive state, other system information requests, small data transmission in the RRC inactive state, etc.

In addition, when the terminal equipment in the connected state performs RRC-configured contention-free random access, if the network device has configured SSB-based dedicated random access resources for the terminal equipment, the terminal equipment is also needed to select an SSB for random access according to the received power (SS-RSRP) of the SSBs of cell currently initiating the random access. After the SSB is selected, the UE determines a next available random access occasion (RO) to which the SSB corresponds, and transmits on the RO a dedicated preamble corresponding to the SSB configured by the network.

Furthermore, when the terminal equipment in the connected state performs RRC-configured contention-free random access, the network may also configure CSI-RS-based dedicated random access resources for contention-free random access. When received power of the CSI-RS is higher than the preset threshold, the terminal equipment selects a dedicated preamble to which the CSI-RS corresponds and an RO for transmitting preambles. For example, when the terminal equipment detects a beam failure, it initiates random access based on contention-free beam failure recovery. In this case, the network may configure CSI-RS-based random access resources for the terminal equipment, but does not configure SSB-based dedicated random access resources.

As the SS-RSRP needing to be measured in the random access procedure needs to be based on a synchronization reference signal (SS) in the SSBs, if the PCell or PSCell of the terminal equipment or the cell where the terminal equipment camps stops transmitting SSBs, the terminal equipment is caused to be unable to normally complete random access.

In the embodiments of this disclosure, when the first cell stops transmitting the first SSB and the terminal equipment in the connected state initiates random access in the first cell (PCell/PSCell) or the terminal equipment in the idle/inactive state initiates random access in the first cell (camping cell), one method is: calculating the SS-RSRP of the first SSB by the terminal equipment by using the SS-RSRP of the second SSB in measuring the received power of the first SSB (SS-RSRP), and selecting first synchronization signal block for random access based on a measurement result (SS-RSRP) of the first SSB; and another method is: measuring the SS-RSRP of the second SSB by the terminal equipment, and selecting the first synchronization signal blocks for random access according to the SS-RSRP of the second SSB. For example, a first SSB having an index identical to that of a second SSB with SS-RSRP higher than the preset threshold is selected to perform random access.

In some embodiments, the terminal equipment selects the second SSB for random access according to the SS-RSRP of the second SSB, and determines that a synchronization signal block associated with PRACH resources of the first cell is the second synchronization signal block. That is, an SSB index to which an SSB in PRACH resource configuration (such as an RO or preamble resource configuration) corresponds refers to an SSB index of the second synchronization signal block. The PRACH resource configuration includes a PRACH of CBRA configured by RACH-ConfigCommon, a PRACH of CFRA configured by RACH-ConfigDedicated, and PRACH resource configuration of BFR configured by BeamFailureRecoveryConfig. For example, when the terminal equipment initiates contention-based random access in the first cell, it determines a random access occasion (RO) of a PRACH resource belong to the first cell to which an index of the selected second SSB of the second cell corresponds according to the PRACH configuration in RACH-ConfigCommon and the index of the selected second SSB of the second cell, then, it randomly selects a preamble belonging to the first cell from a preamble group related to the index of the second SSB of the second cell, and finally, it transmits the selected preamble on a resource corresponding to the selected PRACH random access occasion of the first cell. For example, when the terminal equipment initiates SSB-based contention-free random access in the first cell, after selecting the second SSB, the terminal equipment selects the random access occasion (RO) of the PRACH resources belonging to the first cell according to the PRACH resource configuration in RACH-ConfigDedicated, and determines the dedicated preamble belonging to the first cell to which the index corresponds according to the index of the selected second SSB.

In the embodiments of this disclosure, if the network device configures CSI-RS-based dedicated random access resources for contention-free random access, the terminal equipment performs downlink reception of the CSI-RS in a quasi-colocation relationship with the first synchronization signal block according to the second synchronization signal block. When the terminal equipment receives the CSI-RS in a quasi-colocation relationship with the first synchronization signal block, it takes the second downlink reception parameters for receiving the second synchronization signal block as the first downlink reception parameters for receiving the first synchronization signal block, and receives the CSI-RS according to the first downlink reception parameters. Or, the terminal equipment determines that the quasi-colocation relationship between the CSI-RS and the synchronization signal block of the first cell is identical to the quasi-colocation relationship between the CSI-RS and the synchronization signal block of the second cell, and receives the CSI-RS according to the second downlink reception parameters for receiving the second synchronization signal. When the received power of the CSI-RS is higher than the preset threshold, the terminal equipment selects a dedicated preamble to which the CSI-RS corresponds and an RO for transmitting preambles. For example, when a beam failure is detected, it initiates contention-free beam failure recovery random access.

### (2) CSI-RS-Based or SSB-Based RLM/BFD/RRM Measurement

### Scenario 1: SSB-Based Measurement

In the related art, if a terminal equipment is configured to perform radio link detection or beam failure detection based on SSBs of a first cell, that is, perform measurement on L1 received power of the SSBs of the first cell, but the network device does not transmit the SSBs of the first cell, the terminal equipment is unable to normally complete RLM or BFD.

In the embodiments of this disclosure, the terminal equipment takes the second measurement result of the second synchronization signal block as the first measurement result of the first synchronization signal block in measuring the first synchronization signal block. Or, the terminal equipment determines that a synchronization signal block of radio link detection or beam failure detection based on the first SSB is the second synchronization signal block, and performs evaluation of radio link failure or beam failure of the first cell according to the second measurement result of the second synchronization signal block.

For example, when the terminal equipment in the connected state performs RLM and BFD measurement on the first cell that stops transmitting the first SSB, the terminal equipment determines (considers) that SSB-based reference signals in the RLM/BFD resource configuration for the first cell refer to the second SSBs, that is, an index related the SSB for the RLM/BFD of the first cell is an index of the second SSB. For example, the RLM reference signal configuration information may be expressed as follows by using ASN.1 data format:

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |
| detectionResource | CHOICE { |

ssb-Index SSB-Index,

| | |
|---|---|
| csi-RS-Index | NZP-CSI-RS-ResourceId |
| }, | |
| ... | |

That is, when the first cell stops transmitting the first SSB, the terminal equipment considers that ssb-Index in the RLM reference signal resource configuration information configured for the first cell refers to the index of the second SSB, and performs evaluation of the radio link failure or beam failure of the first cell according to the received power of the second SSB.

In the related art, if a terminal equipment is configured to perform RRM measurement based on SSBs of a first cell, including measurement of L3 received power and received quality or a signal-to-interference radio of the SSBs of the first cell, but the first cell does not transmit the first SSB, the terminal equipment is unable to normally complete the RRM measurement.

In the embodiments of this disclosure, the terminal equipment takes the second measurement result of the second synchronization signal block as the first measurement result of the first synchronization signal block in measuring the first synchronization signal block. Or, the terminal equipment determines that a synchronization signal block for radio resource management measurement is the second synchronization signal block, and measures the second synchronization signal block according to the configuration parameters of the second synchronization signal block, so as to perform radio resource management (RRM) measurement of the first cell. Or, the terminal equipment measures the second cell and takes a measurement result of the second cell as a measurement result of the first cell to report to the network. In another embodiments, if the terminal equipment reports the measurement result of the second cell only, the network side may take the RRM measurement result for the second cell as the measurement result of the first cell.

### Scenario 2: CSI-RS-Based Measurement

In the embodiments of this disclosure, if the above RLM/BFD/RRM measurement is CSI-RS-based measurement, the terminal equipment performs downlink reception of the CSI-RS in a quasi-colocation relationship with the first synchronization signal block according to the second synchronization signal block. When the terminal equipment receives the CSI-RS in a quasi-colocation relationship with the first synchronization signal block, it takes the second downlink reception parameters for receiving the second synchronization signal block as the first downlink reception parameters for receiving the first synchronization signal block, and receives the CSI-RS according to the first downlink reception parameters. Or, the terminal equipment determines that the quasi-colocation relationship between the CSI-RS and the synchronization signal block of the first cell is identical to the quasi-colocation relationship between the CSI-RS and the synchronization signal block of the second cell, receives the CSI-RS according to the second downlink reception parameters for receiving the second synchronization signal, and completes the CSI-RS-based measurement.

For example, TCI state information configured for CSI-RS resources may be expressed as follows by using ASN.1 data format:

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |

cell ServCellIndex

| | |
|---|---|
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |

ssb SSB-Index

| | |
|---|---|
| }, | |
| qcl-Type | ENUMERATED {typeA, typeB, typeC, typeD}, |
| ... | |
| } | |

If a cell field indicates an identifier of the first cell (a cell where a quasi-colocation reference signal of the CSI-RS is located), the terminal equipment may consider that SSBs in a quasi-colocation relationship with the CSI-RS indicated by an SSB field are SSBs with identical indices of the second cell. Or, if the cell field indicates the identifier of the first cell, the terminal equipment considers that the CSI-RS is in a quasi-colocation relationship with a second SSB with identical index of the second cell.

For example, configuration information of the RRM measurement of the CSI-RS in a quasi-colocation relationship with the SSBs of the first cell may be expressed as follows by using ASN.1 data format:

| | |
|---|---|
| CSI-RS-CellMobility ::= | SEQUENCE { |

cellId PhysCellId,

| | |
|---|---|
| csi-rs-MeasurementBW | SEQUENCE { |
| nrofPRBs | ENUMERATED { size24, size48, size96, |
| size192, size264}, | |
| startPRB | INTEGER (0..2169) |
| }, | |
| density | ENUMERATED {d1, d3} |
| OPTIONAL, -- Need R | |
| csi-rs-ResourceList-Mobility | SEQUENCE (SIZE (1..maxNrofCSI-RS- |

ResourcesRRM)) OF CSI-RS-Resource-Mobility

| | |
|---|---|
| } | |
| CSI-RS-Resource-Mobility ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |
| }, | |
| associatedSSB | SEQUENCE { |

```
    ssb-Index SSB-Index,
    isQuasiColocated BOOLEAN
```

| | |
|---|---|
| } | |
| OPTIONAL, -- Need R | |
| frequencyDomainAllocation | CHOICE { |
| row1 | BIT STRING (SIZE (4)), |
| row2 | BIT STRING (SIZE (12)) |
| }, | |
| firstOFDMSymbolInTimeDomain | INTEGER (0..13), |
| sequenceGenerationConfig | INTEGER (0..1023), |
| ... | |
| } | |

If a CellId field indicates an identifier of the first cell, the terminal equipment may consider that SSBs in a quasi-colocation relationship with the CSI-RS indicated by associatedSSB field are SSBs with identical indices of the second cell. Or, if CellId indicates the identifier of the first cell, the terminal equipment considers that the CSI-RS is in a quasi-colocation relationship with a second SSB with identical index.

(3) Cell Selection and/or Reselection

In the related art, when a terminal equipment in an idle or inactive state performs cell selection, the terminal equipment needs to measure SSBs of a serving first cell, and according to a measurement result and cell selection parameters, calculates parameter values representing cell quality, such as Srxlev and Squal. When the parameter values do not satisfy a predetermined condition (an S standard), it is determined that the serving cell or a frequency of the serving cell is not a candidate cell and/or a candidate frequency of the cell selection; otherwise, it is determined that the serving cell or the frequency of the serving cell is a candidate cell and/or candidate frequency of the cell selection.

For example, the S standard is: Srxlev>0 and Squal>0

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ,

Squal=Q_{qualmeas}−(Q_{qualmin}+Q_{qualminoffset})−Qoffsetₜₑₘₚ;
where, Srxlev denotes a cell selection reception level value, Squal denotes cell selection quality, Qoffsetₜₑₘₚ denotes an offset temporarily applied to the cell, Qᵣₛₗₑᵥₘₑₐₛ denotes a cell average received power value obtained through calculation by SS-RSRP measured by using SSBs, P_{compensation} denotes compensation between uplink and downlink power, which is related to maximum transmit power p-Max configured of the cell, and Q_{qualmeas} denotes cell quality obtained through measurement by using SSBs. Hence, a suitable cell is selected according to the candidate cell and/or the candidate frequency and taken as a cell selected by the terminal equipment, so as to complete the cell selection procedure.

In the related art, during a cell reselection procedure, a serving cell is measured, and whether a neighboring cell is measured is determined. For intra-frequency, whether serving cell quality is higher than a threshold S_{IntraaSearchP} or a threshold S_{IntraaSearchQ} is determined, and when it is higher than the threshold, intra-frequency measurement of the neighboring cell is not performed; otherwise, intra-frequency measurement is performed. For inter-frequency, if a priority of an inter-frequency cell or frequency is higher than that of a current serving cell or frequency, the terminal equipment performs inter-frequency measurement on which has higher priority, and if the priority of the inter-frequency cell or frequency is lower than or equal to that of the current serving cell or frequency, whether the quality of a serving cell is higher than a threshold S_{nonIntraSearchP} Or S_{nonIntraSearchQ} is determined. When it is higher than the threshold, inter-frequency measurement is not performed on the neighboring cell (with lower priority); otherwise, inter-frequency measurement is performed. S_{nonIntraSearchP} is a threshold corresponding to reference signal received power (RSRP) for cell quality, and S_{nonIntraSearchQ} is a threshold corresponding to reference signal received quality (RSRQ) for cell quality. It needs to be reselection and evaluated after measurement.

For intra-frequencies and inter-frequencies with identical priority, calculating the following R cell sorting criteria according to the measurement results may be taken into account:

serving cell Rₛ=Q_{meas,s}+Q_{hyst}−Qoffsetₜₑₘₚ,

neighboring cell Rₙ=Q_{meas,n}−Qoffset−Qoffsetₜₑₘₚ;
where, Qmeas denotes a measurement result, and Qoffsetₜₑₘₚ denotes a temporary cell offset value applied when connection fails.

Cells are sorted according to a calculation result, and a cell with a highest rank is reselected. If the cell with the highest rank is in a barred state or is not a suitable cell for a specific reason, the cell is not considered as a candidate cell for cell reselection; otherwise, the cell is reselected.

For inter-frequencies with different priorities, if quality of a cell at an inter-frequency with a reselection priority higher than that of a current serving cell or frequency in a time period is higher than a threshold Thresh_{X, HighP}, reselection to a cell at a frequency with a high priority is performed or a cell at a frequency with a high priority is taken as a best cell. If quality of a cell at an inter-frequency with a reselection priority lower than that of the current serving cell or frequency in a time period is higher than a threshold Thresh_{X, LowP} and quality of the current serving cell is lower than a threshold Thresh_{Serving, LowP}, reselection to a cell at the frequency with a low priority is performed or a cell at the frequency with a low priority is taken as a best cell. If more than one cell satisfies the above criteria, the terminal equipment may reselect a cell at the frequency with the highest priority having a highest rank and satisfying the above criteria, or take a cell at the frequency with the highest priority having a highest rank and satisfying the above criteria as a best cell. If the reselected cell or the best cell obtained according to the above process is in a barred state or is not a suitable cell for a specific reason, the cell is not considered as a candidate cell for cell reselection; otherwise, the cell is reselected.

Hence, in the above process of cell selection or reselection, the measurement result of the first SSB or the measurement result of the first cell is needed. If the first SSB of the first cell is stopped transmitting, the terminal equipment is unable to normally complete cell selection or reselection.

In the embodiments of this disclosure, when the terminal equipment in the idle or inactive state performs measurement of cell selection or reselection, if the first cell stops transmitting the first SSB, measurement of cell selection or reselection performed by the terminal equipment is based on the second cell or the second SSB of the second cell. For example, in measuring the first synchronization signal block, the terminal equipment takes the second measurement result of the second synchronization signal block as the first measurement result of the first synchronization signal block (of identical index), the measurement result including the L3 received power or received quality of the SSBs; or, in measuring the first cell, the terminal equipment takes the measurement result of the second cell as the measurement result of the first cell; or, the terminal equipment measures the second cell to determine the measurement result of the first cell, and performs cell selection or reselection based on the determined measurement result, the measurement result including the L3 received power or received quality of the cell.

It can be seen from the above embodiments that the terminal equipment may perform downlink reception of the reference signal of the energy-saving cell or determine the measurement result of the energy-saving cell according to a synchronization signal block of other cells, and the terminal equipment may perform random access, RLM/BFD/RRM measurement based on CSI-RSs or SSBs and measurement for cell selection or reselection in the energy-saving cell. Thus, the terminal equipment is not necessarily handed over to other cells, and the terminal equipment originally camping on the energy-saving cell does not necessarily perform cell reselection. This may avoid service interruption and increase of the load level of the neighboring cell resulted from migrating the terminal equipment of the energy-saving cell to the neighboring cell, and ensure that user experiences are not reduced when the cell enters the energy-saving state.

### Embodiments of a Second Aspect

The embodiments of this disclosure provide an information transmitting method, which shall be described from a terminal equipment side, with contents identical to those in the embodiment of the first aspect being not going to be repeated herein any further.

FIG. 4 is a schematic diagram of the information transmitting method of the embodiments of this disclosure, applicable to a terminal equipment. As shown in FIG. 4, the method includes:
401: when the terminal equipment initiates random access in a first cell or performs RLM/BFD/RRM measurement based on a first synchronization signal block of a first cell or performs measurement for cell selection or reselection on a first cell, and the terminal equipment fails to receive or measure the first synchronization signal block of the first cell, the terminal equipment transmits a first wake-up signal to a network side device, the first wake-up signal being used to indicate the network side device to resume transmitting the first synchronization signal block of the first cell.

In some embodiments, in 401, when the terminal equipment does not receive second indication information transmitted by the network side device and the terminal equipment initiates random access in the first cell or performs RLM/BFD/RRM measurement based on the first synchronization signal block of the first cell or performs measurement for cell selection or reselection on the first cell, the terminal equipment transmits the first wake-up signal to the network side device, such as carrying the first wake-up signal by a designated PRACH occasion or random access preamble. Reference may be made to the embodiments of the first aspect for implementation of the second indication information, which shall not be repeated herein any further.

That is, that the terminal equipment does not receive the second indication information indicates that the terminal equipment is unable to perform downlink reception of the reference signal of the first cell or determine the measurement result of the first cell according to the second SSB. If the terminal equipment needs to initiate random access or perform RLM/BFD/RRM measurement based on the first synchronization signal block of the first cell or perform measurement for cell selection or reselection on the first cell, it needs to transmit the first wake-up signal to cause the first cell to resume transmission of SSBs.

In some embodiments, the method may further include: the terminal equipment transmits a second wake-up signal to the network side device when the terminal equipment fails to receive or measure the second synchronization signal block of the second cell, the second wake-up signal being used to indicate the network side device to resume transmitting the second synchronization signal block of the second cell.

The first synchronization signal block of the first cell is in a quasi-colocation (QCL) relationship with the second synchronization signal block of the second cell.

In some embodiments, reference may be made to the embodiments of the first aspect for implementations of the first cell, the second cell, the first SSB and the second SSB, which shall not be repeated herein any further.

In some embodiments, the method may further include: the terminal equipment receives first indication information. Reference may be made to the embodiments of the first aspect for implementation of the first indication information, which shall not be repeated herein any further.

It should be noted that the receiving objects of the first and second wake-up signals, executing entities transmitting the first indication information and second indication information, the network device stopping transmitting the first SSB and the network device transmitting the second SSB may be identical or different network devices.

In some embodiments, the method may further include:
402: the terminal equipment receives, the first synchronization signal block that is resumed and transmitted by the network side device; and
403: the terminal equipment performs random access according to the first synchronization signal block, or performs RLM/BFD/RRM measurement or measurement for cell selection or reselection based on the first synchronization signal block of the first cell.

Reference may be made to existing techniques for implementations of 402-403, which shall not be repeated herein any further.

In addition, the terminal equipment may also receive the second synchronization signal block resumed and transmitted by the network side device.

It can be seen from the embodiments of this disclosure that the terminal equipment may transmit a wake-up signal to cause the energy-saving cell that has stopped transmitting SSBs to resume transmission of SSBs, and based on the SSBs resumed to be transmitted, perform random access, RLM/BFD/RRM measurement based on CSI-RSs or SSBs, measurement for cell selection or reselection, etc., in the energy-saving cell. Hence, the terminal equipment is not necessarily handed over to other cells, and the terminal equipment originally camping on the energy-saving cell does not necessarily perform cell reselection, which may avoid service interruption and increase of the load level of the neighboring cell resulted from migrating the terminal equipment of the energy-saving cell to the neighboring cell.

### Embodiments of a Third Aspect

The embodiments of this disclosure provide an information transmitting method, which is processing at a network device side corresponding to the embodiments of the first and second aspects, with contents identical to those in the embodiments of the first and second aspects being not going to be repeated herein any further.

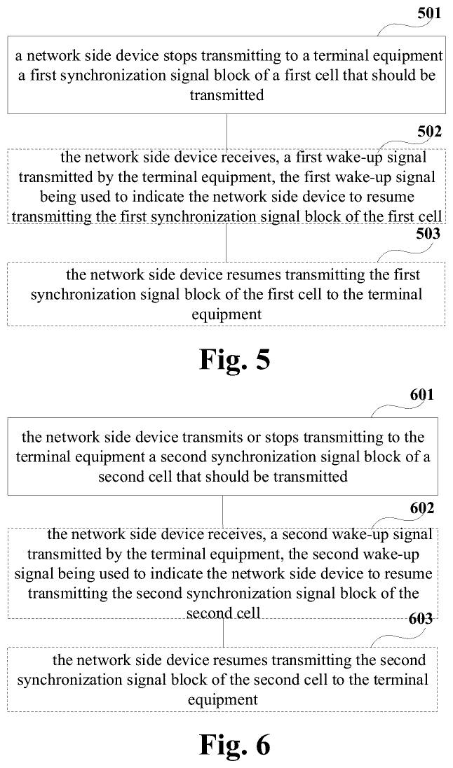

FIG. 5 is a schematic diagram of the information transmitting method of the embodiments of this disclosure. As shown in FIG. 5, the method includes:
501: a network side device stops transmitting to a terminal equipment a first synchronization signal block of a first cell that should be transmitted,
wherein the first synchronization signal block of the first cell and second synchronization signal block of a second cell are in a quasi-colocated (QCL) relationship.

In some embodiments, reference may be made to the embodiments of the first aspect for implementations of the first cell, the second cell, the first SSB and the second SSB, which shall not be repeated herein any further.

In some embodiments, the method may further include: the network side device transmits first indication information to the terminal equipment. Reference may be made to the embodiments of the first aspect for implementation of the first indication information, which shall not be repeated herein any further.

In some embodiments, the network side device transmits second indication information to the terminal equipment. Reference may be made to the embodiments of the first aspect for implementation of the second indication information, which shall not be repeated herein any further.

In some embodiments, in a case where the second indication information is not transmitted, i.e. the terminal equipment is unable to perform downlink reception of the reference signal of the first cell or determine the measurement result of the first cell via the second SSB, the method may further include:
502: the network side device receives, a first wake-up signal transmitted by the terminal equipment, the first wake-up signal being used to indicate the network side device to resume transmitting the first synchronization signal block of the first cell.

In some embodiments, the method further includes:
503: the network side device resumes transmitting the first synchronization signal block of the first cell to the terminal equipment.

In some embodiments, the network side device resumes transmitting the first synchronization signal block of the first cell before transmitting an RRC reconfiguration message, the RRC reconfiguration message being an RRC reconfiguration message used for master cell group (MCG) or secondary cell group (SCG) resynchronization. As contention-free random access indicated by the RRC reconfiguration message for MCG/SCG resynchronization is initiated by the network side device and the contention-free random access for MCG/SCG resynchronization is unable to be based on a CSI-RS, but only on an SSB, the network device needs to resume transmitting the first SSB before transmitting the RRC reconfiguration message, so that the terminal equipment may complete the contention-free random access indicated by the RRC reconfiguration message for MCG/SCG resynchronization based on the first SSB that is resumed transmitting.

FIG. 6 is a schematic diagram of the information transmitting method of the embodiments of this disclosure. As shown in FIG. 6, the method includes:
601: the network side device transmits or stops transmitting to the terminal equipment a second synchronization signal block of a second cell that should be transmitted,
wherein a first synchronization signal block of the first cell and the second synchronization signal block of the second cell are in a quasi-colocated (QCL) relationship.

In some embodiments, the method may further include:
602: the network side device receives, a second wake-up signal transmitted by the terminal equipment, the second wake-up signal being used to indicate the network side device to resume transmitting the second synchronization signal block of the second cell.

In some embodiments, the method further includes:
603: the network side device resumes transmitting the second synchronization signal block of the second cell to the terminal equipment.

In some embodiments, the network side devices in FIGS. 5 and 6 may be identical network devices or different network devices, and the embodiments of this disclosure is not limited thereto.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fourth Aspect

The embodiments of this disclosure provide an information transmitting apparatus. The apparatus may be, for example, a network device, or one or some components or assemblies configured in the network device. The apparatus in the embodiments corresponds to the method in the embodiments of the third aspect, with contents in these embodiments identical to those in the embodiments of the third aspect being not going to be described herein any further.

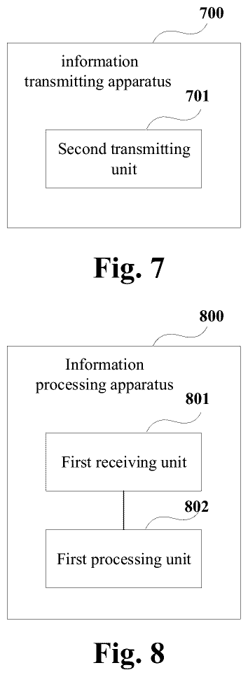

FIG. 7 is a schematic diagram of the information transmitting apparatus of the embodiments of this disclosure. As shown in FIG. 7, an information transmitting apparatus 700 includes:
a second transmitting unit 701 configured to stop transmitting to a terminal equipment a first synchronization signal block of a first cell that should be transmitted, and transmit or stop transmitting to the terminal equipment a second synchronization signal block of a second cell that should be transmitted,
wherein the first synchronization signal block of the first cell and the second synchronization signal block of the second cell are in a quasi-colocated (QCL) relationship.

In some embodiments, the second transmitting unit is further configured to transmit first indication information and or second indication information. Reference may be made to the embodiments of the first aspect for the first indication information and the second indication information.

In some embodiments, the apparatus further includes:
a third receiving unit (not shown) configured to receive a first wake-up signal transmitted by the terminal equipment, the first wake-up signal being used to indicate to resume transmitting the first synchronization signal block of the first cell, or receive a second wake-up signal transmitted by the terminal equipment, the second wake-up signal being used to indicate to resume transmitting the second synchronization signal block of the second cell.

In some embodiments, the second transmitting unit 701 resumes transmitting the first synchronization signal block of the first cell, or resumes transmitting the second synchronization signal block of the second cell.

In some embodiments, the second transmitting unit 701 resumes transmitting the first synchronization signal block of the first cell before transmitting RRC reconfiguration message, the RRC reconfiguration message being an RRC reconfiguration message used for MCG/SCG resynchronization.

Reference may be made to the embodiments of the third aspect for implementation of the second transmitting unit 701, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transmitting apparatus 1700 may further include other components or modules, and reference may be made to related techniques for particulars of these components or modules. Furthermore, the above components or modules may be implemented by hardware, such as a processor, a memory, a transmitter, and a receiver, etc., which are not limited in the embodiments of this disclosure.

### Embodiments of a Fifth Aspect

The embodiments of this disclosure provide an information processing apparatus. The apparatus may be, for example, a terminal equipment, or one or some components or assemblies configured in the terminal equipment. The apparatus in the embodiments correspond to the method in the embodiments of the first or second aspect, with contents in the embodiments identical to those in the embodiments of the first or second aspect being not going to be described herein any further.

FIG. 8 is a schematic diagram of the information processing apparatus of the embodiments of this disclosure. As shown in FIG. 8, an information processing apparatus 800 includes:
a first receiving unit 801 configured to receive a second synchronization signal block (SSB) of a second cell transmitted by a network side device; and
a first processing unit 802 configured to perform downlink reception of a reference signal of a first cell or determine a measurement result of a first cell according to the second synchronization signal block,
wherein a first synchronization signal block of the first cell and the second synchronization signal block of the second cell are in a quasi-colocated (QCL) relationship.

In some embodiments, when the first receiving unit fails to receive the first synchronization signal block transmitted by the network side device, the first processing unit performs downlink reception of the reference signal of the first cell or determines the measurement result of the first cell according to the second synchronization signal block.

In some embodiments, in a synchronization signal block period, the number of the second synchronization signal blocks that are transmitted is not less than the number of the first synchronization signal blocks that should be transmitted.

In some embodiments, the first synchronization signal block and the second synchronization signal block having the quasi-colocated relationship have identical index.

In some embodiments, the first receiving unit is further configured to receive first indication information transmitted by the network side device, the first indication information being used to indicate to stop transmitting the first synchronization signal block that should be transmitted.

In some embodiments, the first indication information is further used to indicate to stop transmitting an index of the first synchronization signal block that should be transmitted.

In some embodiments, the first receiving unit is further configured to receive second indication information transmitted by the network side device, the second indication information being used to indicate identification information of the second cell, or being used to indicate that the first synchronization signal block and the second synchronization signal blocks are in a quasi-colocated relationship, so that the terminal equipment performs downlink reception of the reference signal of the first cell or determines the measurement result of the first cell via the second synchronization signal block.

In some embodiments, the first cell is a special cell (SpCell) when the terminal equipment is in a connected state, or is a selected or reselected cell when the terminal equipment is in an idle state or an inactive state.

In some embodiments, when the first processing unit measures the first synchronization signal block, the first processing unit takes a second measurement result of the second synchronization signal block as a first measurement result of the first synchronization signal block.

In some embodiments, the measurement result includes an L1 measurement result for the first synchronization signal block, or an L3 measurement result for the first synchronization signal block.

In some embodiments, according to a second measurement result of the second synchronization signal block, the first processing unit selects a first synchronization signal block for performing random access in the first cell; or,
according to a second measurement result of the second synchronization signal block, the first processing unit selects a second synchronization signal block for performing random access, and determines that a synchronization signal block associated with a PRACH resource of the first cell is the second synchronization signal block.

In some embodiments, the first processing unit determines that a synchronization signal block of radio link detection or beam failure detection based on the first synchronization signal block is the second synchronization signal block, and performs radio link failure detection or beam failure detection of the first cell according to a second measurement result of the second synchronization signal block.

In some embodiments, the first processing unit determines that a synchronization signal block of radio resource management measurement based on the first synchronization signal block is the second synchronization signal block, and the terminal equipment measures the second synchronization signal block according to a configuration parameter of the second synchronization signal block, so as to perform radio resource management (RRM) measurement of the first cell.

In some embodiments, in measuring the first cell, the first processing unit takes a measurement result of the second cell as a measurement result of the first cell, or measures the second cell to determine a measurement result of the first cell.

In some embodiments, the first processing unit performs downlink reception of a CSI-RS in a quasi-colocated relationship with the first synchronization signal block according to the second synchronization signal block.

In some embodiments, in receiving the CSI-RS in a quasi-colocated relationship with the first synchronization signal block, the first processing unit takes a second downlink reception parameter for receiving the second synchronization signal block as a first downlink reception parameter for receiving the first synchronization signal block, and receives the CSI-RS according to the first downlink reception parameter; or, the first processing unit determines that a quasi-colocated relationship between the CSI-RS and a synchronization signal block of the first cell is identical to a quasi-colocated relationship between the CSI-RS and a synchronization signal block of the second cell, and receives the CSI-RS according to the second downlink reception parameter for receiving the second synchronization signal block.

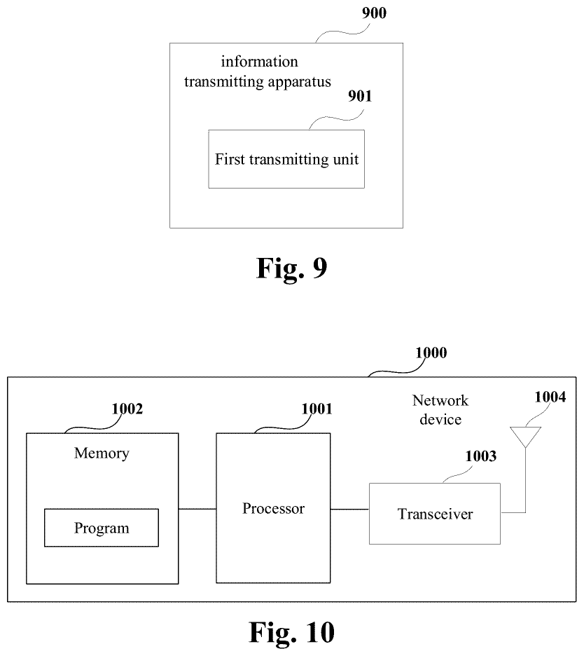

FIG. 9 is a schematic diagram of an example of the information transmitting apparatus of the embodiments of this disclosure. As shown in FIG. 9, an information transmitting apparatus 900 includes:
a first transmitting unit 901 configured to, when the terminal equipment initiates random access in a first cell or performs RLM/BFD/RRM measurement based on a first synchronization signal block of a first cell or performs measurement for cell selection or reselection on a first cell, and the terminal equipment fails to receive or measure the first synchronization signal block of the first cell, transmit a first wake-up signal to a network side device, the first wake-up signal being used to indicate the network side device to resume transmitting the first synchronization signal block of the first cell.

In some embodiments, when the terminal equipment does not receive second indication information transmitted by the network side device and the terminal equipment initiates random access in the first cell or performs RLM/BFD/RRM measurement or measurement for cell selection or reselection based on the first synchronization signal block of the first cell, the first transmitting unit transmits the first wake-up signal to the network side device, wherein the second indication information is used to indicate identification information of the second cell, or is used to indicate that the first synchronization signal block and the second synchronization signal block are in a quasi-colocated relationship, so that the terminal equipment performs downlink reception of the reference signal of the first cell or determines a measurement result of the first cell according to the second synchronization signal block.

In some embodiments, the first transmitting unit transmits a second wake-up signal to the network side device when the terminal equipment fails to receive or measure the second synchronization signal block of the second cell, the second wake-up signal being used to indicate the network side device to resume transmitting the second synchronization signal block of the second cell.

In some embodiments, the apparatus may further include (not shown):
a second receiving unit configured to receive the first synchronization signal block that is resumed and transmitted by the network side device,
and the second processing unit performs at least one of random access, RLM/BFD/RRM measurement and measurement for cell selection or reselection according to the first synchronization signal block.

In some embodiments, the apparatus may further include (not shown):
a third receiving unit configured to receive the first indication information or second indication information transmitted by the network device. Reference may be made to the embodiments of the first aspect for implementations of the first indication information and second indication information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information processing apparatus 800 or the information transmitting apparatus 900 may further include other components or modules, and reference may be made to related techniques for particulars of these components or modules. Furthermore, the above components or modules may be implemented by hardware, such as a processor, a memory, a transmitter, and a receiver, etc., which are not limited in the embodiments of this disclosure.

### Embodiments of a Sixth Aspect

The embodiments of this disclosure provide a communication system, including a network device and a terminal equipment.

In some embodiments, the network device includes the apparatus described in the embodiments of the fourth aspect, and is configured to carry out the method described in the embodiments of the third aspect. As the method has been described in detail in the embodiments of the third aspect, the contents of which are incorporated herein, and shall not be described herein any further.

In some embodiments, the terminal equipment includes the apparatus described in the embodiments of the fifth aspect, and is configured to carry out the method described in the embodiments of the first or second aspect. As the method has been described in detail in the embodiments of the first or second aspect, the contents of which are incorporated herein, and shall not be described herein any further.

The embodiments of this disclosure further provide a network device, which may be, for example, a gNB (a base station in NR), etc.

FIG. 10 is a schematic diagram of the network device of the embodiments of this disclosure. As shown in FIG. 10, a network device 1000 may include a central processing unit (CPU) 1001 and a memory 1002, the memory 1002 being coupled to the central processing unit 1001. The memory 1002 may store various data, and furthermore, it may store a program for information processing, and execute the program under control of the central processing unit 1001, so as to receive various information transmitted by a terminal equipment, and transmit various information to the terminal equipment.

In some embodiments, the functions of the apparatus described in the embodiments of the fourth aspect may be integrated into the central processing unit 1001, and the central processing unit 1001 may be configured to carry out the method described in the embodiments of the third aspect, the contents of which being incorporated herein, which shall not be described herein any further.

In some other embodiments, the apparatus described in the embodiments of the fourth aspect and the central processing unit 1001 may be configured separately; for example, the apparatus described in the embodiments of the fourth aspect may be configured as a chip connected to the central processing unit 1001, and the functions of the apparatus described in the embodiments of the fourth aspect are executed under control of the central processing unit 1001.

Furthermore, as shown in FIG. 10, the network device 1000 may include a transceiver 1003, and an antenna 1004, etc. Functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

The embodiments of this disclosure further provide a terminal equipment, such as a UE.

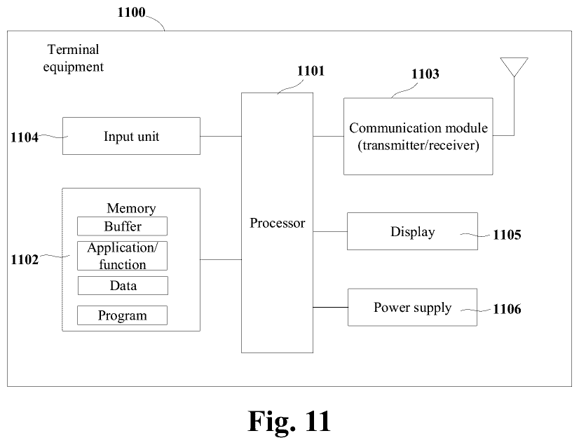

FIG. 11 is a schematic diagram of the terminal equipment of the embodiments of this disclosure. As shown in FIG. 11, a terminal equipment 1100 may include a processor 1101 and a memory 1102, the memory 1102 storing data and a program and being coupled to the processor 1101. It should be noted that this figure is illustrative only, and other types of structures may also be used, so as to supplement or replace this structure and achieve a telecommunications function or other functions.

In some embodiments, the functions of the apparatus described in the embodiments of the fifth aspect may be integrated into the processor 1101, and the processor 1101 may be configured to execute a program to carry out the method described in the embodiments of the first or second aspect, the contents of which being incorporated herein, which shall not be described herein any further.

In some other embodiments, the apparatus described in the embodiments of the fifth aspect and the processor 1101 may be configured separately; for example, the apparatus described in the embodiments of the fifth aspect may be configured as a chip connected to the processor 1101, and the functions of the apparatus described in the embodiments of the fifth aspect are executed under control of the processor 1101.

As shown in FIG. 11, the terminal equipment 1100 may further include a communication module 1103, an input unit 1104, a display 1105, and a power supply 1106, wherein functions of the above components are similar to those in the related art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the related art may be referred to.

Embodiments of this disclosure provides a computer readable program, which, when executed in a terminal equipment, causes the terminal equipment to carry out the method as described in the embodiments of the first or second aspect.

Embodiments of this disclosure provides a computer storage medium, including a computer readable program, which causes a terminal equipment to carry out the method as described in the embodiments of the first or second aspect.

Embodiments of this disclosure provides a computer readable program, which, when executed in a network device, causes the network device to carry out the method as described in the embodiments of the third aspect.

Embodiments of this disclosure provides a computer storage medium, including a computer readable program, which causes a network device to carry out the method as described in the embodiments of the third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information processing method, applicable to a terminal equipment, characterized in that the method includes:
receiving, by the terminal equipment, a second synchronization signal block (SSBs) of a second cell transmitted by a network side device; and
performing downlink reception of a reference signal of a first cell or determining a measurement result of a first cell by the terminal equipment according to the second synchronization signal block,
wherein a first synchronization signal block of the first cell and the second synchronization signal block of the second cell are in a quasi-colocated (QCL) relationship.

2. The method according to supplement 1, wherein,
when the terminal equipment is unable to successfully receive the first synchronization signal block transmitted by the network side device, the terminal equipment performs downlink reception of a reference signal of the first cell or determines a measurement result of the first cell according to the second SSB.

3. The method according to supplement 1 or 2, wherein,
in a synchronization signal block period, the number of the second synchronization signal blocks that are transmitted is not less than the number of the first synchronization signal blocks that should be transmitted.

4. The method according to any one of supplements 1-3, wherein the first synchronization signal block and the second synchronization signal block having the quasi-colocated relationship have identical index.

5. The method according to any one of supplements 1-4, wherein the method further includes:
receiving, by the terminal equipment, first indication information transmitted by the network side device, the first indication information being used to indicate to stop transmitting the first synchronization signal block that should be transmitted.

6. The method according to supplement 5, wherein the first indication information is further used to indicate an index of the stopped transmitted first synchronization signal block that should be transmitted.

7. The method according to any one of supplements 1-6, wherein the method further includes:
receiving, by the terminal equipment, second indication information transmitted by the network side device, the second indication information being used to indicate identification information of the second cell, or being used to indicate that the first synchronization signal block and the second synchronization signal block are in a quasi-colocated relationship, so that the terminal equipment performs downlink reception of the reference signal of the first cell or determines the measurement result of the first cell via the second synchronization signal block.

8. The method according to any one of supplements 1-7, wherein the first cell is a special cell (SpCell) when the terminal equipment is in a connected state, or is a selected or reselected cell when the terminal equipment is in an idle state or an inactive state.

9. The method according to any one of supplements 1-8, wherein the terminal equipment determines the measurement result of the first cell according to the second synchronization signal block.

10. The method according to supplement 9, wherein that the terminal equipment determines the measurement result of the first cell according to the second synchronization signal block includes:
when the terminal equipment measures the first synchronization signal block, taking a second measurement result of the second synchronization signal block as a first measurement result of the first synchronization signal block.

11. The method according to supplement 10, wherein the measurement result includes an L1 measurement result for the first synchronization signal block, or an L3 measurement result for the first synchronization signal block.

12. The method according to supplement 9, wherein that the terminal equipment determines the measurement result of the first cell according to the second synchronization signal block includes:
selecting a first synchronization signal block for performing random access in the first cell by the terminal equipment according to a second measurement result of the second synchronization signal block.

13. The method according to supplement 9, wherein the method further includes:
according to a second measurement result of the second synchronization signal block, selecting a second synchronization signal block for performing random access, and determining that a synchronization signal block associated with a PRACH resource of the first cell is the second synchronization signal block, by the terminal equipment.

14. The method according to supplement 9, wherein that the terminal equipment determines the measurement result of the first cell according to the second synchronization signal block includes:
determining by the terminal equipment that a synchronization signal block of radio link detection or beam failure detection based on the first synchronization signal block is the second synchronization signal block, and performing radio link failure detection or beam failure detection of the first cell by the terminal equipment according to a second measurement result of the second synchronization signal block.

15. The method according to supplement 9, wherein that the terminal equipment determines the measurement result of the first cell according to the second synchronization signal block includes:
determining by the terminal equipment that a synchronization signal block of radio resource management measurement based on the first synchronization signal block is the second synchronization signal block, and measuring the second synchronization signal block by the terminal equipment according to a configuration parameter of the second synchronization signal block, so as to perform radio resource management (RRM) measurement of the first cell.

16. The method according to supplement 9, wherein that the terminal equipment determines the measurement result of the first cell according to the second synchronization signal block includes:
in measuring the first cell, taking a measurement result of the second cell as a measurement result of the first cell by the terminal equipment.

17. The method according to supplement 9, wherein that the terminal equipment determines the measurement result of the first cell according to the second synchronization signal block includes:
measuring the second cell by the terminal equipment to determine a measurement result of the first cell.

18. The method according to any one of supplement 1-8, wherein that the terminal equipment performs downlink reception of the reference signal of the first cell according to the second synchronization signal block includes:
performing downlink reception of a CSI-RS in a quasi-colocated relationship with the first synchronization signal block by the terminal equipment according to the second synchronization signal block.

19. The method according to supplement 18, wherein,
in receiving the CSI-RS in a quasi-colocated relationship with the first synchronization signal block, the terminal equipment takes a second downlink reception parameter for receiving the second synchronization signal block as a first downlink reception parameter for receiving the first synchronization signal block, and receives the CSI-RS according to the first downlink reception parameter.

20. The method according to supplement 18, wherein,
the terminal equipment determines that a quasi-colocated relationship between the CSI-RS and a synchronization signal block of the first cell is identical to a quasi-colocated relationship between the CSI-RS and a synchronization signal block of the second cell, and receives the CSI-RS according to the second downlink reception parameter for receiving the second synchronization signal block.

21. An information transmitting method, applicable to a terminal equipment, characterized in that the method includes:
when the terminal equipment initiates random access in a first cell or performs RLM/BFD/RRM measurement based on a first synchronization signal block of a first cell or performs measurement for cell selection or reselection on a first cell, and the terminal equipment fails to receive or measure the first synchronization signal block of the first cell, transmitting a first wake-up signal to a network side device, the first wake-up signal being used to indicate the network side device to resume transmitting the first synchronization signal block of the first cell.

22. The method according to supplement 21, wherein the first cell is a special cell (SpCell) of the terminal equipment when it is in a connected state, or a cell selected or reselected by the terminal equipment when it is in an idle or inactive state.

23. The method according to supplement 21 or 22, wherein the method further includes:
receiving, by the terminal equipment, first indication information transmitted by a network side device;
wherein the first indication information is used to indicate the network device to stop transmitting the first synchronization signal block that should be transmitted.

24. The method according to supplement 21 or 22, wherein,
when the terminal equipment does not receive second indication information transmitted by the network side device and the terminal equipment initiates random access in the first cell or performs RLM/BFD/RRM measurement or measurement for cell selection or reselection based on the first synchronization signal block of the first cell, the terminal equipment transmits the first wake-up signal to the network side device, wherein the second indication information is used to indicate identification information of the second cell, or is used to indicate that the first synchronization signal block and the second synchronization signal block are in a quasi-colocated relationship, so that the terminal equipment performs downlink reception of the reference signal of the first cell or determines a measurement result of the first cell according to the second synchronization signal block.

25. The method according to supplement 24, wherein the method further includes:
transmitting a second wake-up signal by the terminal equipment to the network side device when the terminal equipment fails to receive or measure the second synchronization signal block of the second cell, the second wake-up signal being used to indicate the network side device to resume transmitting the second synchronization signal block of the second cell.

26. The method according to any one of supplements 21-25, wherein the method further includes:
receiving, by the terminal equipment, the first synchronization signal block that are resumed and transmitted by the network side device; and
performing at least one of random access, RLM/BFD/RRM measurement and measurement for cell selection or reselection according to the first synchronization signal block.

27. The method according to any one of supplements 21-26, wherein in a synchronization signal block period, the number of the second synchronization signal blocks that are transmitted is not less than the number of the first synchronization signal blocks that should be transmitted.

28. The method according to any one of supplements 21-27, wherein the first synchronization signal block and the second synchronization signal block having the quasi-colocated relationship have identical index.

29. An information transmitting method, applicable to a network side device, characterized in that the method includes:
stopping transmitting to a terminal equipment a first synchronization signal block of a first cell that should be transmitted, and transmitting or stopping transmitting to the terminal equipment a second synchronization signal block of a second cell that should be transmitted, by the network side device,
wherein the first synchronization signal block of the first cell and the second synchronization signal block of the second cell are in a quasi-colocated (QCL) relationship.

30. The method according to supplement 29, wherein in a synchronization signal block period, the number of the second synchronization signal blocks that are transmitted is not less than the number of the first synchronization signal blocks that should be transmitted.

31. The method according to supplement 29 or 30, wherein the first synchronization signal block and the second synchronization signal block having the quasi-colocated relationship have identical index.

32. The method according to supplement 29 or 30, wherein the method further includes:
transmitting first indication information by the network side device to the terminal equipment, the first indication information being used to indicate to stop transmitting the first synchronization signal block that should be transmitted.

33. The method according to supplement 32, wherein the first indication information is further used to indicate an index of the stopped transmitted first synchronization signal block that should be transmitted.

34. The method according to any one of supplements 29-33, wherein the method further includes:
transmitting second indication information by the network side device to the terminal equipment, the second indication information being used to indicate identification information of the second cell, or being used to indicate that the first synchronization signal block and the second synchronization signal block are in a quasi-colocated relationship, so that the terminal equipment performs downlink reception of the reference signal of the first cell or determines the measurement result of the first cell via the second synchronization signal block.

35. The method according to supplement 29, wherein the method further includes:
receiving, by the network side device, a first wake-up signal transmitted by the terminal equipment, the first wake-up signal being used to indicate to resume transmitting the first synchronization signal block of the first cell, or, receiving, by the network side device, a second wake-up signal transmitted by the terminal equipment, the second wake-up signal being used to indicate to resume transmitting the second synchronization signal block of the second cell.

36. The method according to supplement 35, wherein the method further includes:
resuming transmitting the first synchronization signal block of the first cell, or resuming transmitting the second synchronization signal block of the second cell, by the network side device to the terminal equipment.

37. The method according to supplement 35, wherein the network side device resumes transmitting the first synchronization signal block of the first cell before transmitting an RRC reconfiguration message, the RRC reconfiguration message being an RRC reconfiguration message used for master cell group (MCG) or secondary cell group (SCG) resynchronization.

38. A network device, including a memory and a processor, the memory storing a computer program, and the processor being configured to execute the computer program to carry out the method as described in any one of supplements 29-37.

39. A terminal equipment, including a memory and a processor, the memory storing a computer program, and the processor being configured to execute the computer program to carry out the method as described in any one of supplements 1-28.

40. A communication system, including the network device as described in supplement 38 and/or the terminal equipment as described in supplement 39.

1. An information processing apparatus, for a terminal equipment, the apparatus comprising:
a receiver configured to receive first indication information transmitted by a network side device, the first indication information being used to indicate identification information of a first cell, and receive a first synchronization signal block (SSB) of the first cell transmitted by the network side device; and
processor circuitry configured to perform downlink reception of a reference signal of a second cell;
wherein the reference signal of the second cell and the first synchronization signal block of the first cell are in a quasi-colocated (QCL) relationship.

2. The apparatus according to claim 1, wherein the processor circuitry performs the downlink reception of a reference signal of a second cell according to the first SSB.

3. The apparatus according to claim 1, wherein the second cell is SSB-less cell.

4. The apparatus according to claim 1, wherein the second cell is SCell.

5. The apparatus according to claim 1, wherein the second cell is collocated with the first cell which is an active reference serving cell.

6. The apparatus according to claim 1, wherein the first cell is PCell or SCell or PScell or SpCell.

7. The apparatus according to claim 1, wherein the first indication information is carried by RRC signaling.

8. The apparatus according to claim 1, wherein the indication information of the first cell is a serving cell index of the first cell.

9. The apparatus according to claim 1, wherein the quasi-collocated (QCL) relationship is QCL-TypeC.

10. The apparatus according to claim 1, wherein the reference signal includes CSI-RS or SSB.

11. The apparatus according to claim 1, wherein,
when the receiver fails to receive a synchronization signal block transmitted by the network side device in the second cell, the processor circuitry performs downlink reception in the second cell according to the first synchronization signal block.

12. The apparatus according to claim 1, wherein
when the receiver fails to receive an SSB configuration information transmitted by the network side device in the second cell, the processor circuitry performs downlink reception in the first cell according to the first synchronization signal block.

13. The apparatus according to claim 1, wherein the receiver is further configured to receive second indication information transmitted by the network side device, the second indication information being used to indicate to stop transmitting the second synchronization signal block that should be transmitted on the first cell.

14. The apparatus according to claim 1, wherein the apparatus further includes a transmitter configured to transmit a first wake-up signal to a network side device, the first wake-up signal being used to indicate the network side device to resume transmitting a synchronization signal block of the second cell.

15. The apparatus according to claim 14, wherein the receiver further configured to receive the synchronization signal block that are resumed and transmitted by the network side device.

16. The apparatus according to claim 15, wherein
the processor circuitry performs at least one of random access, RLM/BFD/RRM measurement and measurement for cell selection or reselection according to the synchronization signal block of the second cell.

17. An information transmitting apparatus, for a network side device, the apparatus comprising:
a transmitter configured to stop transmitting to a terminal equipment a second synchronization signal block of a second cell that should be transmitted, and transmit to the terminal equipment a first synchronization signal block of a first cell that should be transmitted;
the transmitter transmits first indication information to the terminal equipment, the second indication information being used to indicate identification information of the first cell; wherein the first synchronization signal block used to perform downlink reception of a reference signal of the second cell;
wherein the reference signal of the second cell and the first synchronization signal block of the first cell are in a quasi-colocated (QCL) relationship.

18. A communicating system, comprising:
a terminal equipment including an information processing apparatus comprising:
a receiver configured to receive first indication information transmitted by a network side device, the first indication information being used to indicate identification information of a first cell, and receive a first synchronization signal block (SSB) of the first cell transmitted by the network side device; and
processor circuitry configured to perform downlink reception of a reference signal of a second cell;
wherein the reference signal of the second cell and the first synchronization signal block of the first cell are in a quasi-colocated (QCL) relationship; and
a network side device including an information transmitting apparatus comprising:
a transmitter configured to stop transmitting to a terminal equipment a second synchronization signal block of a second cell that should be transmitted, and transmit to the terminal equipment a first synchronization signal block of a first cell that should be transmitted;
the transmitter transmits first indication information to the terminal equipment, the second indication information being used to indicate identification information of the first cell; wherein the first synchronization signal block used to perform downlink reception of a reference signal of the second cell;
wherein the reference signal of the second cell and the first synchronization signal block of the first cell are in a quasi-colocated (QCL) relationship.
